(19) United States
(12) Patent Application Publication
(10) Pub. No.: US 2026/0104744 A1
(43) Pub. Date: Apr. 16, 2026

(54) ELECTRONIC DEVICE

(71) Applicant: SAMSUNG DISPLAY CO., LTD., YONGIN-Si (KR)

(72) Inventors: JUNGEUN LEE, Yongin-si (KR); YONGKWON SOH, Yongin-si (KR); Junsu LEE, Yongin-si (KR); Yeonwoo KIM, Yongin-si (KR)

(21) Appl. No.: 19/301,280

(22) Filed: Aug. 15, 2025

(30) Foreign Application Priority Data
Oct. 16, 2024 (KR) 10-2024-0141211

(51) Int. Cl. G06F 1/16

(52) U.S. Cl. CPC G06F 1/1681; G06F 1/1641; G06F 1/1656

(57) ABSTRACT

An electronic device includes a display module, a support plate, a first adhesive part, and a first groove. The support plate has a first surface that faces the display module, and a second surface that is opposite to the first surface. The support plate includes a first support plate, a second support plate, and a folding part interposed between the first support plate and the second support plate. The first adhesive part contacts the second surface. The first groove is defined in the second surface and adjacent to the first adhesive part. The first groove is recessed in a thickness direction of the support plate to limit a flow of the first adhesive part beyond a boundary separating the first groove and the first adhesive part.

### CROSS-REFERENCE TO RELATED APPLICATIONS

This application claims priority under 35 U.S.C. § 119 to Korean Patent Application No. 10-2024-0141211, filed on Oct. 16, 2024, the disclosure of which is incorporated by reference herein in its entirety.

### TECHNICAL FIELD

Embodiments of the present disclosure relate to an electronic device.

### DISCUSSION OF RELATED ART

Electronic devices that provide visual information to users—such as, for example, smartphones, digital cameras, laptop computers, navigation systems, and smart televisions—typically include a display through which images are presented. These devices generate and output images to users via the display.

In recent years, advancements in electronic device technology have led to the development of various new form factors. Among them are flexible electronic devices that can be curved, bent, or rolled. These flexible devices offer improved portability and enhance user convenience by allowing the device shape to change as needed.

A representative example of a flexible electronic device is a foldable electronic device, which includes a display module that can be folded along a folding axis extending in one direction. The display module can transition between folded and unfolded states about this axis. A portion of the display module, referred to as the folding region, is configured to bend during folding operations and may adopt a specific radius of curvature when folded.

### SUMMARY

Embodiments of the present disclosure provide an electronic device having increased reliability.

According to an embodiment of the present disclosure, an electronic device includes a display module, a support plate having a first surface that faces the display module and a second surface that is opposite to the first surface, a first adhesive part, and a first groove. The support plate includes a first support plate, a second support plate, and a folding part interposed between the first support plate and the second support plate. The first adhesive part contacts the second surface. The first groove is defined in the second surface and is adjacent to the first adhesive part. The first groove is recessed in a thickness direction of the support plate to limit a flow of the first adhesive part beyond a boundary separating the first groove and the first adhesive part.

In an embodiment, the folding part includes a curved surface part, a first inverse curvature part interposed between the first support plate and the curved surface part, and a second inverse curvature part interposed between the second support plate and the curved surface part. The curved surface part is bent to have a specific curvature, and the first inverse curvature part and the second inverse curvature are bent to be opposite to the curved surface part, when the folding part is folded.

In an embodiment, the first adhesive part overlaps the first inverse curvature part and the second inverse curvature part.

In an embodiment, a thickness of the support plate is thicker than a depth of the first groove.

In an embodiment, the first support plate, the folding part, and the second support plate are arranged in a first direction, and the first groove extends in a second direction crossing the first direction.

In an embodiment, the electronic device further includes a second adhesive part that contacts the second surface. The second adhesive part is formed along portions of outer sides of the first support plate and the second support plate.

In an embodiment, the first adhesive part and the second adhesive part are disposed in the same layer.

In an embodiment, the second adhesive part is spaced apart from the first adhesive part.

In an embodiment, the second adhesive part and the first adhesive part include different materials.

In an embodiment, the electronic device further includes a second groove defined in the second surface of the support plate and surrounding the second adhesive part.

In an embodiment, the electronic device further includes a third adhesive part that contacts the second surface. The third adhesive part overlaps the first support plate and the second support plate.

In an embodiment, the first adhesive part and the third adhesive part are disposed in the same layer.

In an embodiment, the electronic device further includes a third groove defined in the second surface and surrounding the third adhesive part.

In an embodiment, the third adhesive part and the first adhesive part include different materials.

According to an embodiment of the present disclosure, an electronic device includes a display module, a support plate disposed under the display module and including a first support plate, a second support plate, and a folding part interposed between the first support plate and the second support plate, in which the first support plate, the second support plate, and the folding part are arranged in a first direction. The electronic device further includes a support part disposed under the support plate, and including a first support part corresponding to the first support plate and a second support part corresponding to the second support plate, and a first adhesive part interposed between the support plate and the support part. The electronic device further includes a groove defined in a surface of the support places that faces the first adhesive part. The groove surrounds the first adhesive part.

In an embodiment, the first adhesive part overlaps the folding part, the first adhesive part includes a plurality of first adhesive parts, and the plurality of first adhesive parts are spaced apart from each other in the first direction.

In an embodiment, the electronic device further includes a second adhesive part disposed under the support plate and spaced apart from the first adhesive part. The first adhesive part and the second adhesive part are disposed in the same layer.

In an embodiment, the second adhesive part is disposed along a portion of an outer side of each of the first support plate and the second support plate, the second adhesive part includes a plurality of second adhesive parts, and the plurality of second adhesive parts are spaced apart from each other in the first direction.

In an embodiment, the electronic device further includes a cushion layer disposed under the support part and including a first cushion layer and a second cushion layer. The first cushion layer overlaps the first support part, and the second cushion layer overlaps the second support part.

In an embodiment, the electronic device further includes a third adhesive part disposed under the support plate. The third adhesive part includes a plurality of third adhesive parts, the plurality of third adhesive parts are spaced apart from each other in the first direction, and the plurality of third adhesive parts overlap the first cushion layer and the second cushion layer, respectively.

### BRIEF DESCRIPTION OF THE DRAWINGS

The above and other objects and features of the present disclosure will become more apparent by describing in detail embodiments thereof with reference to the accompanying drawings.

FIG. 1 is a perspective view of an electronic device according to an embodiment of the present disclosure.

FIG. 2 is a view illustrating the folding state of the electronic device illustrated in FIG. 1.

FIG. 3 is an exploded perspective view of the electronic device illustrated FIG. 1.

FIG. 4 is a block diagram of the electronic device illustrated in FIG. 3.

FIG. 5 is a cross-sectional view illustrating an electronic panel including a display panel illustrated in FIG. 3.

FIG. 6 is a cross-sectional view illustrating the display panel illustrated in FIG. 5.

FIG. 7 is a plan view of a display panel illustrated in FIG. 3.

FIG. 8 is a cross-sectional view taken along line I-I′ illustrated in FIG. 7.

FIG. 9 is a perspective view of a support plate illustrated in FIG. 8.

FIG. 10 is an enlarged plan view of a region AA illustrated in FIG. 9.

FIGS. 11A and 11B are cross-sectional views taken along line II-II′ illustrated in FIG. 10.

FIG. 12 is a view illustrating an electronic device in a folding state, illustrated in FIG. 8.

FIG. 13 is a plan view of a support plate of an electronic device according to an embodiment of the present disclosure.

FIG. 14 is a perspective view of a support plate of an electronic device according to an embodiment of the present disclosure.

FIG. 15 is a perspective view of a support plate of an electronic device according to an embodiment of the present disclosure.

FIG. 16 is a diagram illustrating an electronic device according to an embodiment of the present disclosure.

### DETAILED DESCRIPTION

Embodiments of the present disclosure will be described more fully hereinafter with reference to the accompanying drawings. Like reference numerals may refer to like elements throughout the accompanying drawings.

It should be understood that descriptions of features or aspects within each embodiment should typically be considered as available for other similar features or aspects in other embodiments, unless the context clearly indicates otherwise.

Spatially relative terms, such as “beneath”, “below”, “lower”, “under”, “above”, “upper”, etc., may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” or “under” other elements or features would then be oriented “above” the other elements or features. Thus, the example terms “below” and “under” can encompass both an orientation of above and below.

It will be understood that when a component is referred to as being “on”, “connected to”, “coupled to”, or “adjacent to” another component, it can be directly on, connected, coupled, or adjacent to the other component, or intervening components may be present. It will also be understood that when a component is referred to as being “between” two components, it can be the only component between the two components, or one or more intervening components may also be present. It will also be understood that when a component is referred to as “covering” another component, it can be the only component covering the other component, or one or more intervening components may also be covering the other component. The words used to describe the relationships between components should be interpreted in a like fashion.

Although the terms “first”, “second”, etc. may be used to describe various components, the components should not be construed as being limited by the terms. The terms are only used to distinguish one component from another component. For example, without departing from the scope and spirit of the present disclosure, a first component may be referred to as a second component, and similarly, the second component may be referred to as the first component.

It will be further understood that the terms “comprise,” “include,” or “including,” or “have” or “having” specify the presence of stated features, numbers, steps, operations, components, parts, or the combination thereof, but do not preclude the presence or addition of one or more other features, numbers, steps, operations, components, components, and/or the combination thereof.

In a foldable electronic device, applying adhesive materials in the folding region may present challenges due to the curvature and deformation that occur during folding and unfolding. Excess adhesive can spread beyond the intended area, causing defects such as, for example, delamination, deformation, or mechanical interference. To address this, embodiments of the present disclosure provide a structural solution that allows precise control of adhesive placement and containment in the folding region of a foldable display device.

For example, embodiments of the present application provide a support plate positioned under the display module, which may include a first support plate, a second support plate, and a folding part interposed between the first and second support plates. A liquid adhesive may be applied to the second surface of the support plate in a region including the folding part to bond the support plate to underlying components. To control the behavior of the adhesive, a groove may be formed in the second surface of the support plate along the boundary of the adhesive application region. This groove may both as a surface-tension-based boundary to contain the adhesive and as a physical dam or drain that may capture overflow in the event of application errors.

By using the groove to regulate adhesive flow, embodiments of the present application enable consistent bonding performance, even in the curved or flexible regions of the support structure. The configuration may prevent adhesive from spreading into unintended areas such as the non-folding support plates or other sensitive regions of the device. As a result, the reliability and durability of the foldable electronic device, and the manufacturability and robustness of the adhesive application process, may be improved.

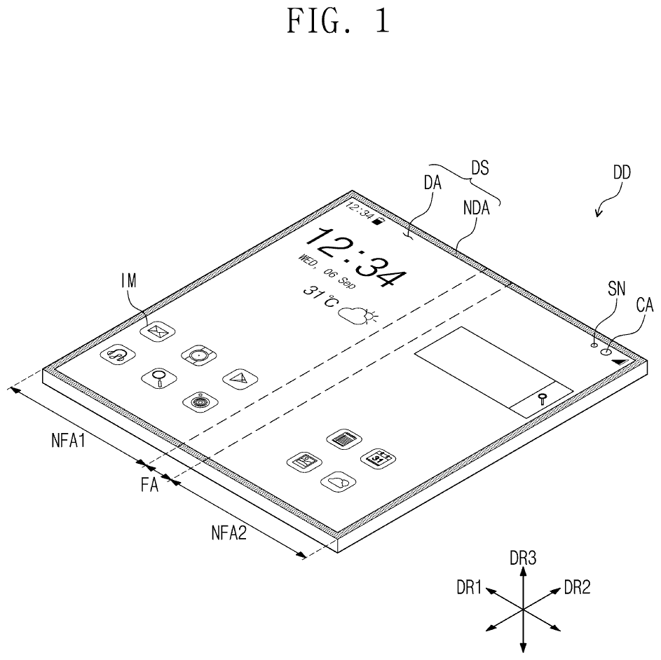

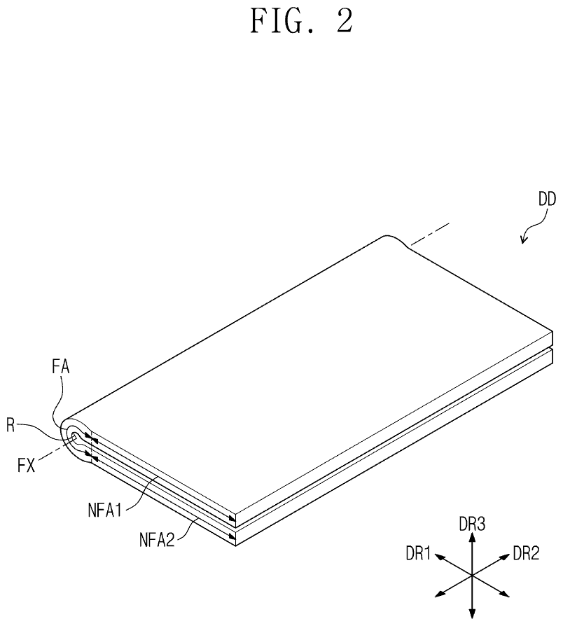

FIG. 1 is a perspective view of an electronic device according to an embodiment of the present disclosure. FIG. 2 is a view illustrating a folding state of the electronic device illustrated in FIG. 1.

Referring to FIG. 1, according to an embodiment of the present disclosure, an electronic device DD may have a shape of a rectangle having a shorter side extending in a first direction DR1 and a longer side extending in a second direction DR2 crossing the first direction DR1. However, the present disclosure is not limited thereto. For example, the electronic device DD may be implemented in various shapes such as a circle and a polygon. The electronic device DD may be a flexible electronic device.

Hereinafter, a direction substantially perpendicular to a plane defined by the first direction DR1 and the second direction DR2 is defined as a third direction DR3. In addition, in the specification, the expression “when viewed in a plan view” may be defined as a state of being viewed in the third direction DR3.

The electronic device DD may include a folding region FA and a plurality of non-folding regions NFA1 and NFA2. The non-folding regions NFA1 and NFA2 may include a first non-folding region NFA1 and a second non-folding region NFA2. The folding region FA may be interposed between the first non-folding region NFA1 and the second non-folding region NFA2. The first non-folding region NFA1, the folding region FA, and the second non-folding region NFA2 may be arranged in the first direction DR1.

For example, although one folding region FA and two non-folding regions NFA1 and NFA2 are illustrated, the number of the folding region FA and the non-folding regions NFA1 and NFA2 is not limited thereto. For example, the electronic device DD may include a plurality of non-folding regions having more than two non-folding regions, and a plurality of folding regions interposed between the non-folding regions.

A top surface of the electronic device DD may be defined as a display surface DS, and the display surface DS may have a plane defined in the first direction DR1 and the second direction DR2. Images IM generated from the display device DD may be provided through the display surface DS.

The display surface DS may include a display region DA and a non-display region NDA around the display region DA. An image may be displayed in the display region DA, and is not displayed in the non-display region NDA. The non-display region NDA may surround the display region DA and may define an edge of the electronic device DD printed in a specific color. For example, the non-display region NDA may correspond to a bezel area of the display device DD.

The electronic device DD may include at least one sensor SN and at least one camera CA. The sensor SN and the camera CA may be disposed adjacent to the edge of the electronic device DD. The sensor SN and the camera CA may be provided in the display region DA adjacent to the non-display region NDA. Although the sensor SN and the camera CA may be disposed in the second non-folding region NFA2, the present disclosure is not limited thereto. For example, in an embodiment, the sensor SN and the camera CA may be provided in the first non-folding region NFA1.

As light is transmitted through parts of the electronic device DD, in which the sensor SN and the camera CA are provided, the light may be provided to the camera CA and the sensor SN. For example, the sensor SN may be a proximity sensor, but the type of the sensor SN is not limited thereto. The camera CA may capture an external image. A plurality of sensors SN and a plurality of cameras CA may be provided.

Referring to FIG. 2, the electronic device DD may be a foldable display device DD which is folded or unfolded. For example, as the folding region FA is bent about the folding axis FX parallel to the second direction DR2, the electronic device DD may be folded. The folding axis FX may be defined as a longer axis parallel to a longer side of the electronic device DD. However, the present disclosure is not limited thereto. For example, in an embodiment, the folding axis FX may be a shorter axis parallel to a shorter side, and the electronic device DD may be folded about the folding axis FX parallel to the shorter side.

When the electronic device DD is folded, the first non-folding region NFA1 and the second non-folding region NFA2 may face each other, and the electronic device DD may be in an in-folding state in which the display surface FS is not exposed. However, an embodiment of the present disclosure is not limited thereto. For example, in an embodiment, the electronic device DD may be in an out-folding state in which the display surface DS is exposed when folded.

The distance between the first non-folding region NFA1 and the second non-folding region NFA2 may be less than the diameter of a circle defined by the radius R of curvature of the folding region FA. In this case, the folding region FA may be folded in the shape of a dumbbell, and the distance between the first non-folding region NFA1 and the second non-folding region NFA2 may be shorter.

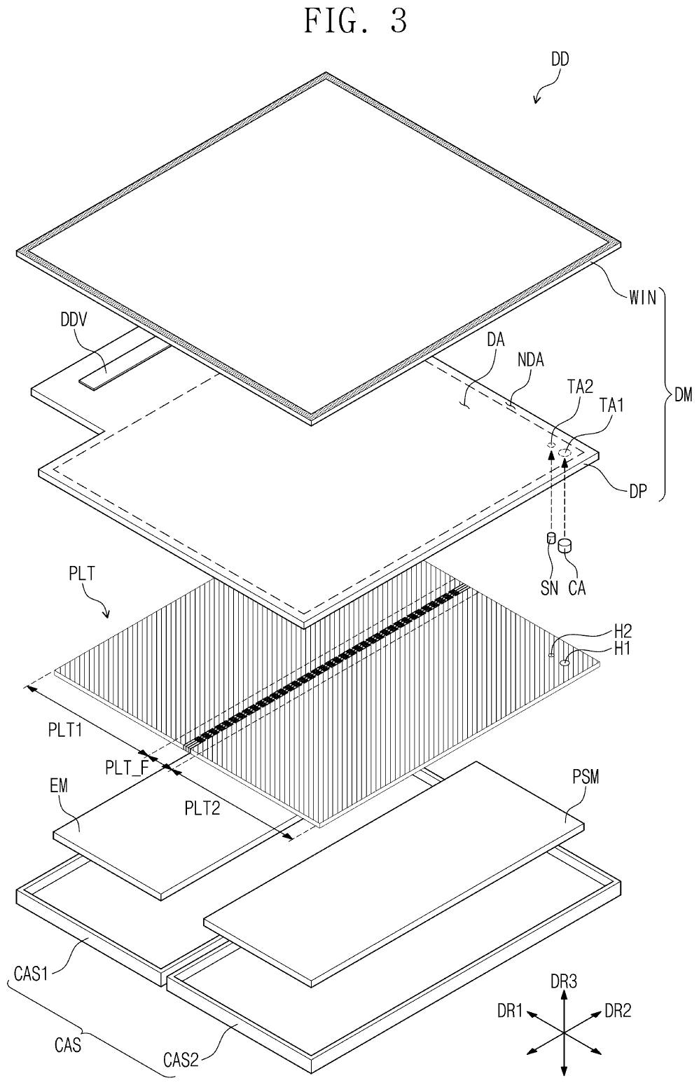

FIG. 3 is an exploded perspective view of the electronic device of FIG. 1.

Referring to FIG. 3, the electronic device DD may include a display module DM, a camera CA, a sensor SN, a support plate PLT, an electronic module EM, a power supply module PSM, and a case CAS.

The display module DM may include a window WIN and the display panel DP. For example, although FIG. 3 includes the window WIN and the display panel DP in the stack structure of the display module DM, the display module DM may further include various components in addition the window WIN and the display panel DP. Hereinafter, the stack structure of the display module DM will be described in detail.

The window WIN may be provided on a front surface of the electronic device DD. The window WIN may transmit an image generated from the display panel DP and may provide the image to the user.

The display panel DP may include a display region DA and a non-display region NDA corresponding to the display region DA (see FIG. 1) and the non-display region NDA (see FIG. 1) of the electronic device DD, respectively. In the present disclosure, the wording “a region/part correspond to a region/part” refers to that the region/part overlaps the region/part”, and does not refer to that the region/part has an area the same as an area of the region/part.

A first transmission region TA1 and a second transmission TA2 may be defined in the display panel DP. The first transmission region TA1 and the second transmission region TA2 may have light transmittance higher than that of the surrounding areas. The camera CA may be provided under the first transmission region TA1, and the sensor SN may be provided under the second transmission region TA2. The light transmitted through the first and second transmission regions TA1 and TA2 may be provided to the camera CA and the sensor SN.

The display module DM may include a data driver DDV disposed in the non-display region NDA of the display panel DP. The data driver DDV may be manufactured in the form of an integral circuit chip and mounted in the non-display region DNA. However, the present disclosure is not limited thereto. For example, in an embodiment, the data driver DDV may be mounted on a flexible circuit substrate connected to the display panel DP.

The support plate PLT may be disposed under the display module DM to support the display module DM. The support plate PLT may include a first support plate PLT1, a second support plate PLT2, and a folding part PLT_F. The folding part PLT_F may be interposed between the first support plate PLT1 and the second support plate PLT2. The first support plate PLT1, the folding part PLT_F, and the second support plate PLT2 may be arranged in the first direction DR1.

For example, according to embodiments, the support plate PLT may be disposed beneath the display module DM and may serve to physically support and reinforce the display module DM, for example, in both flat and folded configurations of the electronic device DD. The support plate PLT may include three distinct structural regions: a first support plate PLT1, a second support plate PLT2, and a folding part PLT_F that mechanically links the two support plates. The folding part PLT_F may be positioned between the first support plate PLT1 and the second support plate PLT2 to allow the support plate PLT to flex or bend about a folding axis. These three regions—the first support plate PLT1, the folding part PLT_F, and the second support plate PLT2—may be linearly arranged in the first direction DR1, which corresponds to the folding direction of the electronic device DD. This configuration may enable the support plate PLT to accommodate folding motion while maintaining structural integrity in the unfolded state, thereby contributing to both the flexibility and durability of the overall display structure

For example, according to embodiments, the support plate PLT is a structural member disposed beneath the display module DM and configured to provide mechanical support, rigidity, or controlled flexibility to the display module DM and surrounding components. The support plate PLT may be made of any material suitable for supporting a display module DM in both folded and unfolded states, including, but not limited to, metals (e.g., aluminum alloy, stainless steel), fiber-reinforced composites (e.g., carbon fiber reinforced plastic (CFRP), glass fiber reinforced plastic (GFRP)), polymers, or layered structures thereof. In some embodiments, the support plate PLT may include curved, grooved, or patterned regions to facilitate bending or improve adhesive containment. The support plate PLT is not limited to a rigid structure and may encompass partially flexible or elastic configurations, depending on the mechanical requirements of the foldable device.

A first hole H1 and a second hole H2 may be defined in the second support plate PLT2. The first hole H1 and the second hole H2 may be adjacent to the edge of the second support plate PLT2. The camera CA and the sensor SN may be disposed in the first hole H1 and the second hole H2, respectively.

The electronic module EM and the power supply module PSM may be disposed under the support plate PLT. The electronic module EM and the power supply module PSM may be connected to each other through an additional flexible circuit board. The electronic module EM may control the operation of the display module DM. The power supply module PSM may supply power to the electronic module EM.

The case CAS may receive the window module DM, the electronic module EM, and the power supply module PSM. The case CAS may include two cases, for example, a first case CAS1 and a second CAS2, to fold the display module DM. The first and second cases CAS1 and CAS2 may extend (e.g., lengthwise) in the second direction DR2 and may be arranged in the first direction DR1.

The electronic device DD may further include a hinge structure that connects the first case CAS1 to the second case CAS2 and rotates the first case CAS1 to the second case CAS2 such that the electronic device DD is folded. The case CAS may protect the display module DM, the electronic module EM, and the power supply module PSM.

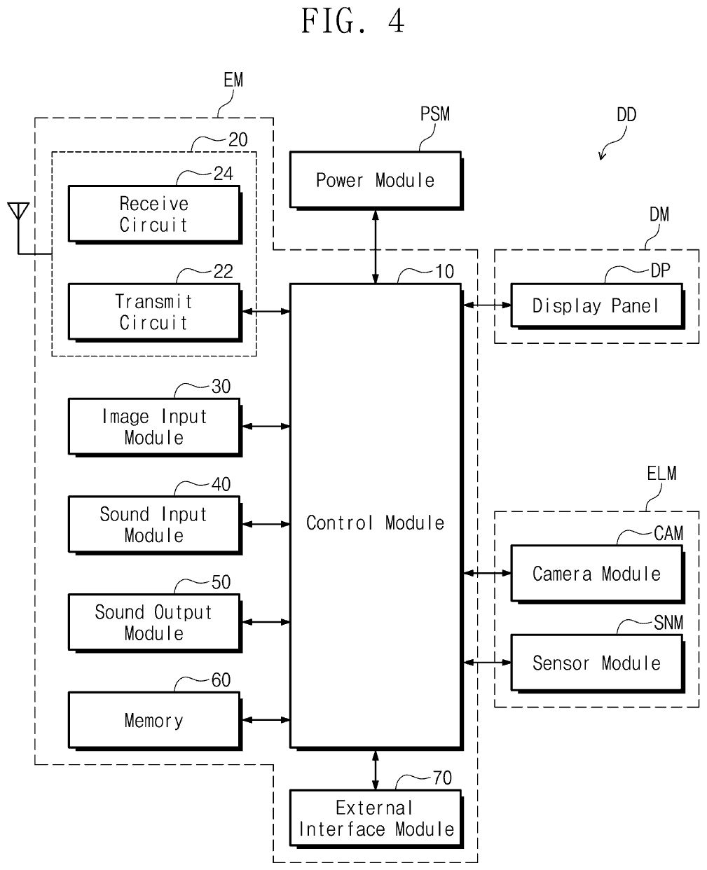

FIG. 4 is a block diagram of the electronic device illustrated in FIG. 3.

Referring to FIG. 4, the electronic device DD may include the electronic module EM, the power supply module PSM, the display module DM, and an electronic-optical module ELM. The electronic module EM includes a control module 10, a wireless communication module 20, an image input module 30, a sound input module 40, a sound output module 50, a memory 60, and an external interface module 70. The above modules may be mounted on a circuit board or may be electrically connected to each other through a flexible circuit board. The electronic module EM may be electrically connected to the power module PSM.

The control module 10 may control the overall operation of the electronic device 100. For example, the control module 10 may activate or deactivate the display module DM to be matched with a user input. The control module 10 may control the image input module 30, the sound input module 40, and the sound output module 50 to be matched to the user input. The control module 10 may include at least one microprocessor.

The wireless communication module 20 may transmit/receive a wireless signal to/from another terminal through a Bluetooth or Wi-Fi connection. The wireless communication module 20 may transmit/receive a voice signal by using a general communication channel. The wireless communication module 20 includes a transmit circuit 22 that modulates and transmits a signal to be transmitted, and a receive circuit 24 that demodulates a received signal.

The image input module 30 may process an image signal to be converted into image data to be displayed in the display module DM. In a record mode or a voice recognizing mode, the sound input module 40 may receive an external sound signal through a microphone and may convert the received sound signal into electrical voice data. The sound output module 50 may convert sound data received from the wireless communication module 20 or sound data stored in a memory 60 and may output the converted result.

The external interface module 70 may function as an interface for connection with, e.g., an external charger, a wired/wireless data port, or a card socket (e.g., a memory card, or a SIM/UIM card socket).

The power supply module PSM may supply power utilized for the overall operation of the electronic device DD. The power supply module PSM may include a general battery device.

The electronic-optical module ELM may be an electronic part that outputs or receives an optical signal. The electronic-optical module ELM may transmit or receive an optical signal through a partial region of the display module DM. According to an embodiment, the electronic-optical module ELM may include the camera module CAM and the sensor module SNM. The camera module CAM may include the camera CA illustrated in FIG. 3. The sensor module SNM may include the sensor SN illustrated in FIG. 3.

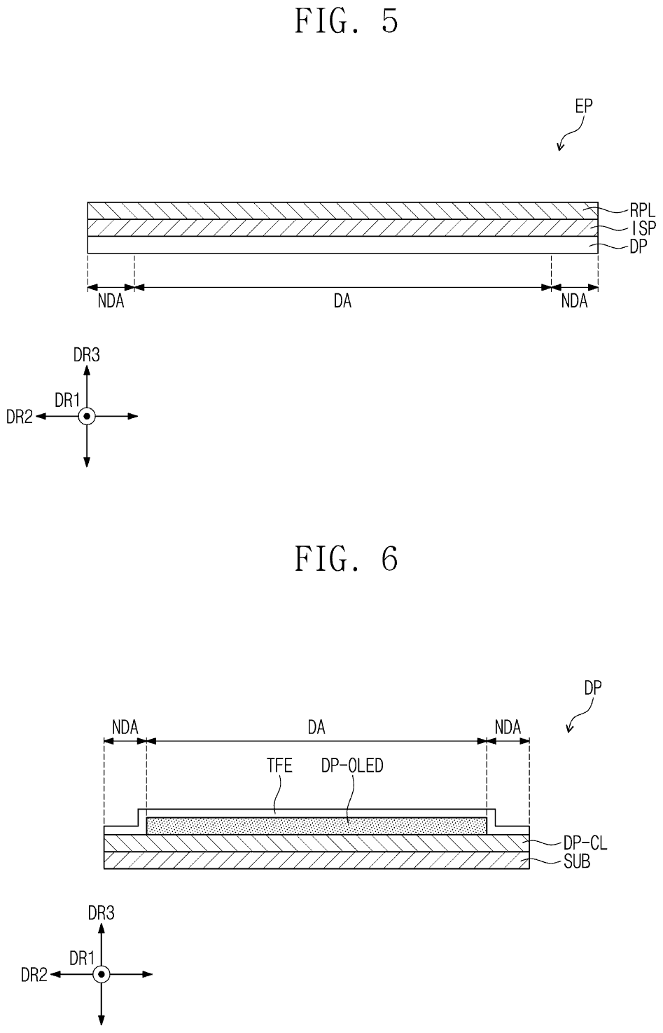

FIG. 5 is a cross-sectional view illustrating an electronic panel including the display panel illustrated in FIG. 3. FIG. 6 is a cross-sectional view illustrating the display panel illustrated in FIG. 5.

For example, FIGS. 5 and 6 illustrate cross-sectional views in the first direction DR1.

Referring to FIG. 5, the electronic panel EP may include the display panel DP, an input sensing unit ISP disposed on the display panel DP, and an anti-reflective layer RPL disposed on the input sensing unit ISP. The display module DM described above may include the electronic panel EP.

The display panel DP may include a flexible display panel. According to an embodiment of the present disclosure, the display panel DP may be a light emissive-type display panel, but the present disclosure is not limited thereto. For example, in an embodiment, the display panel DP may be an organic emission display panel or an inorganic emission display panel. An emission layer of the organic emission display panel may include an organic emission material. The emission layer of the inorganic emission display panel may include a quantum dot or a quantum rod. The following description will be made under the assumption that the display panel DP is an organic emission display panel.

The input sensing unit ISP may include a plurality of sensing units that sense an external input in a capacitive manner. The input sensing unit ISP may be manufactured directly on the display panel DP when the electronic device DD is manufactured. However, the present disclosure is not limited thereto. For example, in an embodiment, the input sensing unit ISP is manufactured separately from the display panel DP, and may be bonded to the display panel DP by an adhesive layer.

The anti-reflective layer RPL may be manufactured directly on the input sensing unit ISP when the electronic device DD is manufactured. However, the present disclosure is not limited thereto. For example, in an embodiment, the anti-reflective layer RPL may be manufactured separately from the input sensing unit ISP and may be bonded to the input sensing unit ISP through the adhesive layer.

The anti-reflective layer RPL may be a film that prevents external light from being reflected. The anti-reflective layer RPL may reduce the reflectance of external light incident from the top surface of the display device DD toward the display panel DP.

Referring to FIG. 6, the display panel DP may include a substrate SUB, a circuit element layer DP-CL disposed on the substrate SUB, a display element layer DP-OLED disposed on the circuit element layer DP-CL, and a thin film encapsulating layer TFE disposed on the display element layer DP-OLED.

The substrate SUB may include the display region DA and the non-display region NDA around the display region DA. The substrate SUB may include a flexible plastic material such as, for example, glass or polyimide (PI). The display element layer DP-OLED may be disposed in the display region DA.

A plurality of pixels may be disposed in the circuit element layer DP-CL and the display element layer DP-OLED. Each of the pixels may include a transistor disposed in the circuit element layer DP-CL and an emission element disposed in the display element layer DP-OLED and connected to the transistor.

The thin film encapsulating layer TFE may be disposed on the circuit element layer DP-CL and may cover the display element layer DP-OLED. The thin film encapsulating layer TFE may protect the pixels from, for example, moisture, oxygen, and external foreign substances.

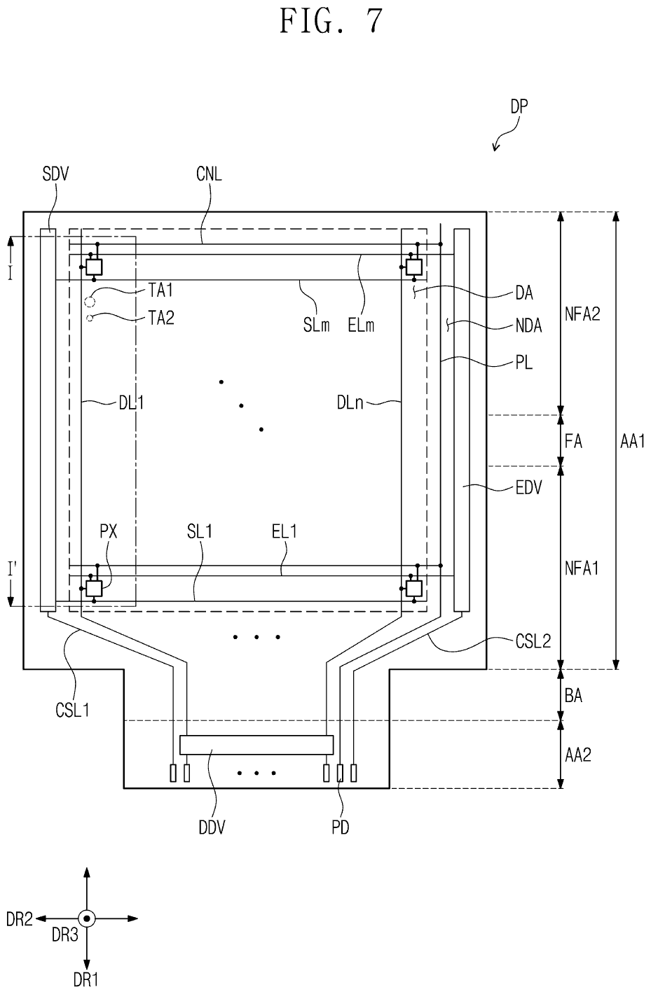

FIG. 7 is a cross-sectional view illustrating a display panel illustrated in FIG. 3.

Referring to FIG. 7, the display module DM may include the display panel DP, a scan driver SDV, a data driver DDV, and an emission driver EDV.

The display panel DP may include a first region AA1, a second region AA2, and a bending region BA disposed between the first region AA1 and the second region AA2. The bending region BA may extend in the second direction DR2, and the first region AA1, the bending region BA, and the second region AA2 may be arranged in the first direction DR1.

The first region AA1 may include the display region DA and the non-display region NDA around the display region DA. The non-display region NDA may surround the display region DA. The display region DA may be a region in which an image is displayed, and the non-display region NDA may be a region in which the image is not displayed. The second region AA2 and the bending region BA may be regions in which the image is not displayed.

The first region AA1 may include a first non-folding region NFA1, a second non-folding region NFA2, and a folding region FA interposed between the first non-folding region NFA1 and the second non-folding region NFA2 when viewed in the second direction DR2. The first and second non-folding regions NFA1 and NFA2 and the folding region FA may respectively correspond to the first and second non-folding regions NFA1 and NFA2 and the folding region FA of the electronic device DD illustrated in FIG. 1. The first and second transmission regions TA1 and TA2 may be defined in the display region DA and the second non-folding region NFA2, respectively.

The first region AA1 may be bent about the folding axis FX described above and may be folded. For example, as the folding region FA of the first region AA1 is folded about the folding axis FX described above, the display panel DP may be folded.

The display panel DP may include a plurality of pixels PX, a plurality of scan lines SL1 to SLm, a plurality of data lines DL1 to DLn, the plurality of emission lines EL1 to ELm, first and second control lines CSL1 and CSL2, a power line PL, a plurality of connecting lines CNL, and a plurality of pads PD. In this case, ‘m’ and ‘n’ are positive integers. The pixels PX may be disposed in the display region DA, and may be connected to the scan lines SL1 to SLm, the data lines DL1 to DLn, and the emission lines EL1 to ELm.

The scan driver SDV and the emission driver EDV may be disposed in the non-display region NDA. The scan driver SDV and the emission driver EDV may be disposed in the non-display region NDA adjacent to sides of the first region AA1, which are opposite to each other in the second direction DR2. The data driver DDV may be disposed in the second region AA2. The data driver DDV may be manufactured in the form of an integrated circuit chip and may be mounted on the second region AA2.

The scan lines SL1 to SLm may be connected to the scan driver SDV while extending in the second direction DR2. The data lines DL1 to DLn may extend in the first direction DR1 and may be connected to the data driver DDV through the bending region BA. The data driver DDV may be applied to the pixels PX through the data lines DL1 to DLn. The emission lines EL1 to ELm may extend in the second direction DR2 to be connected to the emission driver EDV.

The power line PL may extend in the first direction DR1 and may be disposed in the non-display region NDA. The power line PL may be interposed between the display region DA and the emission driver EDV. The power line PL may extend to the second region AA2 through the bending region BA. The power line PL may extend toward a lower end portion of the second region AA2 when viewed in a plan view. The power line PL may receive a driving voltage.

The connection lines CNL may extend in the second direction DR2 and may be arranged in the first direction DR1. The connecting lines CNL may be connected to the power line PL and the pixels PX. The driving voltage may be applied to the pixels PX through the power line PL and the connecting lines CNL connected to each other.

The first control line CSL1 may be connected to the scan driver SDV and may extend to the lower end of the second region AA2 through the bending region BA. The second control line CSL2 may be connected to the emission driver EDV and may extend to the lower end of the second region AA2 through the bending region BA. The data driver DDV may be disposed between the first control line CSL1 and the second control line CSL2.

When viewed in a plan view, the pads PD may be disposed adjacent to the lower end of the second region AA2. The data driver DDV, the power line PL, the first control line CSL1, and the second control line CSL2 may be connected with the pads PD.

The data lines DL1 to DLn may be connected to relevant pads PD through the data driver DDV. For example, the data lines DL1 to DLn may be connected to the data driver DDV, and the data driver DDV may be connected to pads corresponding to the data lines DL1 to DLn.

A printed circuit board may be connected to the pads PD, and the timing controller and the voltage generator may be disposed on the printed circuit board. The timing controller may be manufactured in the form of an integrated circuit chip and may be mounted on the printed circuit board. The timing controller and the voltage generator may be connected to the pads PD through the printed circuit board.

The timing controller may control the operations of the scan driver SDV, the data driver DDV, and the emission driver EDV. The timing controller may generate a scan control signal, a data control signal, and an emission control signal in response to external control signals. The voltage generator may generate a driving voltage.

The scan control signal may be provided to the scan driver SDV through the first control line CSL1. The emission control signal may be provided to the emission driver EDV through the second control line CSL2. The data control signal may be provided to the data driver DDV. The timing controller may receive image signals, and convert the data format of the image signals to be matched to the interface specification with the data driver DDV, such that the converted signals are provided to the data driver DDV.

The scan driver SDV may generate a plurality of scan signals in response to the scan control signal. The scan signals may be applied to the pixels PX through the scan lines SL1 to SLm. The scan signals may be sequentially applied to the pixels PX.

The data driver DDV may generate a plurality of data voltages respectively corresponding to the image signals in response to the data control signal. The data voltages may be applied to the pixels PX through the data lines DL1-DLn. The emission driver EDV may generate a plurality of emission signals in response to the emission control signal. The emission signals may be applied to the pixels PX through the emission lines EL1 to ELm.

The pixels PX may receive the data voltages in response to the scan signals. The pixels PX may display images by emitting a light of brightness corresponding to the data voltages in response to the emission signals. The emission time the pixels PX may be controlled by the emission signals.

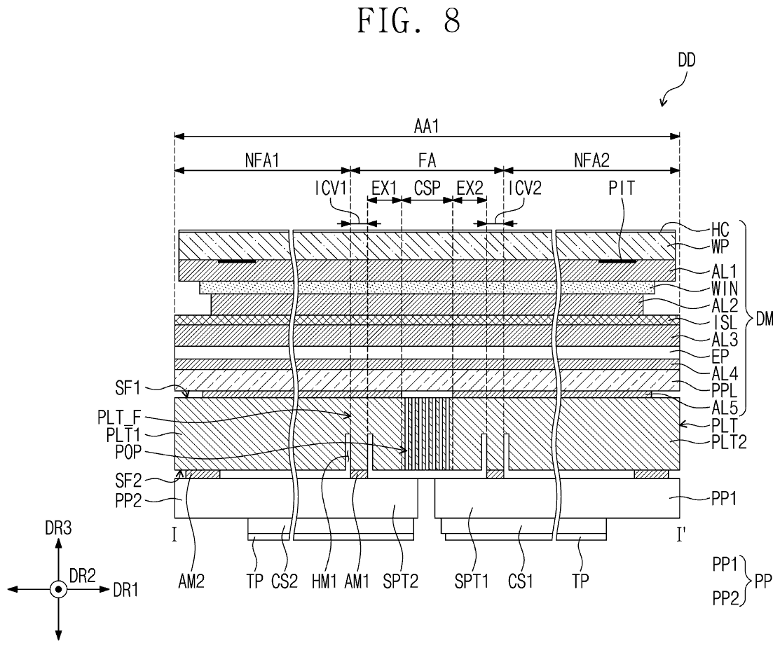

FIG. 8 is a cross-sectional view taken along line I-I′ illustrated in FIG. 7.

FIG. 8 illustrates a cross-section of the display module DM corresponding to line I-I′ and a cross-section disposed under the display module DM.

Referring to FIG. 8, the electronic device DD may include the display module DM, the support plate PLT, a support part PP, a first cushion layer CS1, a second cushion layer CS2, an insulating layer TP, and adhesive parts AM1 and AM2.

The display module DM may include the window WIN, a window protecting layer WP, a hard coating layer HC, a printing layer PIT, an impact absorbing layer ISL, an electronic panel EP, and a panel protecting layer PPL. The electronic device DD may include first to fifth adhesive layers AL1 to AL5 to bond the components to each other.

The display module DM may include a flexible display module. The display module DM may include a first non-folding region NFA1, a folding region FA, and a second non-folding region NFA2. As the folding region FA is folded about the folding axis FX described above, the display module DM may be folded.

The window WIN may be disposed on the impact absorbing layer ISL. The window WIN may protect the electronic panel EP from external scratches. The window WIN may have optically transparent properties. The window WIN may include glass. However, the present disclosure is not limited thereto, and the window WIN may include, for example, a synthetic resin film.

The window WIN may have a multi-layer structure or a single-layer structure. For example, the window WIN may include a plurality of synthetic resin films bonded to each other by an adhesive agent, or may include a glass substrate and a synthetic resin film coupled to each other by the adhesive agent.

The window protecting layer WP may be disposed on the window WIN. The window protecting layer WP may include a flexible plastic material such as, for example, polyimide or polyethylene terephthalate. The hard coating layer HC may be disposed on a top surface of the window protecting layer WP.

The printing layer PIT may be disposed on a bottom surface of the window protecting layer WP. Although the printing layer PIT may have a black color, the color of the printing layer PIT is not limited thereto. The printing layer PIT may be disposed adjacent to an edge of the window protecting layer WP.

The impact absorbing layer ISL may be disposed on the electronic panel EP. The impact absorbing layer ISL may protect the electronic panel EP by absorbing an external impact applied toward the electronic panel EP from above the electronic device DD. The impact absorbing layer ISL may be manufactured in the form of a stretchable film.

The impact absorbing layer ISL may include a flexible plastic material. The flexible plastic material may be defined as a synthetic resin film. For example, the impact absorbing layer ISL may include a flexible plastic material such as polyimide (PI) or polyethyleneterephthalte (PET).

The panel protecting layer PPL may be disposed under the electronic panel EP. The panel protecting layer PPL may be disposed under the display panel DP. The panel protecting layer PPL may protect a lower portion of the display panel DP. The panel protecting layer PPL may include a flexible plastic material. For example, the panel protecting layer PPL may include polyethylene terephthalate (PET).

The first adhesive layer AL1 may be interposed between the window protecting layer WP and the window WIN. The window protecting layer WP and the window WIN may be bonded to each other by the first adhesive layer AL1. The first adhesive layer AL1 may cover the printing layer PIT.

The second adhesive layer AL2 may be interposed between the window WIN and the impact absorbing layer ISL. The window WIN and the impact absorbing layer ISL may be bonded to each other by the second adhesive layer AL2.

The third adhesive layer AL3 may be interposed between the impact absorbing layer ISL and the electronic panel EP. The impact absorbing layer ISL and the electronic panel EP may be bonded to each other by the third adhesive layer AL3.

The fourth adhesive layer AL4 may be interposed between the electronic panel EP and the panel protecting layer PPL. The electronic panel EP and the panel protecting layer PPL may be bonded to each other by the fourth adhesive layer AL4. The fifth adhesive layer AL5 may cover the panel protecting layer PPL.

The support plate PLT may be disposed under the display module DM to support the display module DM. The support plate PLT may be formed from a variety of materials suitable for maintaining mechanical stability while permitting the desired degree of flexibility or rigidity, depending on the region of the support plate. For example, the support plate PLT may include a metal material or a non-metal material. In some embodiments, the support plate PLT may include a fiber-reinforced composite such as, for example, carbon fiber reinforced plastic (CFRP) or glass fiber reinforced plastic (GFRP). However, the present disclosure is not limited to these examples, and other materials having appropriate mechanical properties may also be used for the support plate PLT.

A plurality of openings POP may be defined in a portion, which overlaps the folding region FA, of the support plate PLT. The openings POP may be formed through portions of the support plate PLT in the third direction DR3. The openings POP may be formed through an etching process.

The support plate PLT may include the first support plate PLT1, the second support plate PLT2, and the folding part PLT_F. For example, boundaries between the first support plate PLT1 and the folding part PLT_F, and between the second support plate PLT2 and the folding part PLT_F, are illustrated in the form of dotted lines on the support plate PLT.

The support plate PLT may have a first surface SF1 and a second surface SF2 defined on the support plate PLT. The first surface SF1 may face the display module DM. For example, the first surface SF1 may be disposed opposite to the display module DM. The second surface SF2 may face the first surface SF1. For example, the second surface SF2 may be disposed opposite to the first surface SF1. For example, the first surface SF1 may be referred to as a top surface of the support plate PLT, and the second surface SF2 may be referred to a bottom surface of the support plate PLT.

The folding part PLT_F may be interposed between the first support plate PLT1 and the second support plate PLT2. The first support plate PLT1, the folding part PLT_F, and the second support plate PLT2 may be arranged in the first direction DR1. The openings POP may be defined in the folding part PLT_F.

Hereinafter, in this specification, the wording “overlap” may be defined as portions of components that overlap each other when viewed in a plan view, in the electronic device disposed in a flat state.

The first support plate PLT1 may be disposed under the first non-folding region NFA1, and may overlap the first non-folding region NFA1. The second support plate PLT2 may be disposed under the second non-folding region NFA2, and may overlap the second non-folding region NFA2. The folding part PLT_F may be disposed under the folding region FA, and may overlap the folding region FA.

The folding part PLT_F may include a curved surface part CSP, a first extending part EX1, a second extending part EX2, a first inverse curvature part ICV1, and a second inverse curvature part ICV2. For example, although boundaries among the curved surface part CSP, the first extending part EX1, the second extending part EX2, the first inverse curvature part ICV1, and the second inverse curvature part ICV2 are illustrated in the form of dotted lines on the support plate PLT, the above reference numerals are also included for convenience of explanation.

The curved surface part CSP, the first extending part EX1, the second extending part EX2, the first inverse curvature part ICV1, and the second inverse curvature part ICV2 may be arranged in the first direction DR1. For example, the curved surface part CSP may be disposed at the central portion of the folding part PLT_F. The first inverse curvature part ICV1 may be defined as a portion of the folding part PLT_F adjacent to the first support plate PLT1. The second inverse curvature part ICV2 may be defined as a portion of the folding part PLT_F adjacent to the second support plate PLT2.

The curved surface part CSP may be interposed between the first extending part EX1 and the second extending part EX2. The openings POP may be defined in the curved surface part CSP. When the folding part PLT_F is folded, the curved surface part CSP may be bent to have a specific curvature. As the openings POP is defined in the curved surface part CSP, the flexibility of the curved surface part CSP may be increased. Accordingly, the curved surface part CSP may be easily folded.

The first extending part EX1 may be interposed between the first inverse curvature part ICV1 and the curved surface part CSP. The second extending part EX2 may be interposed between the second inverse curvature part ICV2 and the curved surface part CSP.

The first inverse curvature part ICV1 may be interposed between the first support plate PLT1 and the curved surface part CSP. For example, the first inverse curvature part ICV1 may be interposed between the first support plate PLT1 and the first extending part EX1. The second inverse curvature part ICV2 may be interposed between the second support plate PLT2 and the curved surface part CSP. For example, the second inverse curvature part ICV2 may be interposed between the second support plate PLT2 and the second extending part EX2.

The fifth adhesive layer AL5 may be interposed between the panel protecting layer PPL and the support plate PLT. The panel protecting layer PPL and the support plate PLT may be bonded to each other by the fifth adhesive layer AL5. In an embodiment, the fifth adhesive layer AL5 is not disposed in a region overlapping the curved surface part CSP. The fifth adhesive layer AL5 may have an opening formed in the region overlapping the curved surface part CSP.

Although the first to fifth adhesive layers AL1 to AL5 may include a transparent adhesive agent, such as a pressure sensitive adhesive (PSA) or an optically clear adhesive (OCA), the type of the adhesive agent is not limited thereto.

Components disposed under the support plate PLT may be referred to as lower members. Although FIG. 8 illustrates that the support part PP is attached to a lower portion of the support plate PLT, the configuration of the lower members attached to the lower portion of the support plate PLT according to an embodiment of the present disclosure is not limited thereto. For example, a digitizer may be attached to the lower portion of the support plate PLT. The digitizer may be a device that receives information about a position indicated by a user on the display surface. The digitizer may be implemented in an electro-magnetic scheme (or an electromagnetic resonance scheme). For example, the digitizer may include a digitizer sensor substrate including a plurality of coils. However, the present disclosure is not limited thereto. The digitizer may be implemented in an active electrostatic scheme.

When a user moves a pen on the electronic device DD, the pen is driven by an alternating current (AC) signal to generate a vibrating magnetic field, and the vibrating magnetic field may induce a signal to the coil. The position of the pen may be detected through the signal induced to the coil. The digitizer may detect the position of the pen by sensing the electromagnetic change made as the pen approaches.

The support part PP may be disposed under the support plate PLT. The support part PP may include a first support part PP1 and a second support part PP2. The support part PP may provide structural reinforcement and impact protection, and may be formed of a material having a higher modulus than that of the support plate PLT. For example, the support part PP may include a metal material, such as an aluminum alloy, or a composite material, such as carbon fiber reinforced plastic (CFRP). However, the material of the support part PP is not limited to these examples, and other materials having suitable mechanical strength may also be used.

The first and second support parts PP1 and PP2 may support the display module DM. When viewed in a plan view, the first support part PP1 may overlap the second non-folding region NFA2. The first support part PP1 may correspond to the second support plate PLT2.

The first support part PP1 and the second support part PP2 may face each other. The first support part PP1 and the second support part PP2 may be spaced apart from each other in the first direction DR1. When viewed in a plan view, the first support part PP1 may be in a non-overlap state with the second support part PP2.

The first support part PP1 may have a modulus higher than a modulus of the support plate PLT. Accordingly, the first support part PP1 may stably protect display module DM from an external impact. For example, the first support part PP1 may include an aluminum alloy or carbon fiber reinforced plastic.

The first cushion layer CS1 and the insulating layer TP may be provided under the first support part PP1. The first cushion layer CS1 may overlap the first support part PP1 when viewed in a plan view.

The first cushion layer CS1 may protect the display module DM by absorbing external impact. The first cushion layer CS1 may include a foam sheet having a specific elasticity. The first cushion layer CS1 may include sponge or polyurethane.

The insulating layer TP may be disposed under the first cushion layer CS1. The insulating layer TP may include an insulating film. The insulating layer TP may prevent static electricity from being introduced.

The second support part PP2 may be disposed under the support plate PLT. The second support part PP2 may support the display module DM. When viewed in a plan view, the second support part PP2 may overlap the first non-folding region NFA1. The second support part PP2 may correspond to the first support plate PLT1.

The second support part PP2 may have a modulus higher than a modulus of the support plate PLT. Accordingly, the second support part PP2 may stably protect the display module DM from an external impact. For example, the second support part PP2 may include an aluminum alloy or carbon fiber reinforced plastic.

The second cushion layer CS2 and the insulating layer TP may be provided under the second support part PP2. The second cushion layer CS2 may overlap the second support part PP2 when viewed in a plan view.

The second cushion layer CS2 may protect the display module DM by absorbing external impact. The second cushion layer CS2 may include a foam sheet having a specific elasticity. The second cushion layer CS2 may include sponge or polyurethane.

The insulating layer TP may be disposed under the second cushion layer CS2. The insulating layer TP may include an insulating film. The insulating layer TP may prevent static electricity from being introduced.

The adhesive parts AM1 and AM2 may be interposed between the support plate PLT and the support part PP. The support part PP may be bonded to the support plate PLT by the adhesive parts AM1 and AM2. The adhesive parts AM1 and AM2 may include the first adhesive part AM1 and the second adhesive part AM2.

For example, according to embodiments, the adhesive parts AM1 and AM2 may be interposed between the support plate PLT and underlying components, and may be formed using different adhesive materials selected based on their location and required mechanical performance. The first adhesive part AM1, which may be disposed in a folding region overlapping inverse curvature portions of the support plate PLT, may include a liquid adhesive agent, such as glue, that provides relatively high bonding strength. This adhesive may be applied thinly and uniformly, and may be controlled by an adjacent groove to prevent overflow and maintain precise application. The second adhesive part AM2, which may be disposed in flat, non-folding regions along the outer sides of the support plate PLT, may include a transparent adhesive agent such as a pressure-sensitive adhesive (PSA) or an optically clear adhesive (OCA). In some embodiments, the adhesive parts AM1 and AM2 may be formed in the same layer but may include mutually different materials selected to match the mechanical demands of each region.

The first adhesive part AM1 may contact (e.g., directly contact) the second surface SF2 of the support plate PLT. The first adhesive part AM1 may overlap the folding part FA1. The first adhesive part AM1 may include a plurality of first adhesive parts. The first adhesive parts AM1 may be spaced apart from each other in the first direction DR1. For example, the first adhesive parts AM1 may overlap the first inverse curvature part ICV1 and the second inverse curvature part ICV2.

The second adhesive part AM2 may contact (e.g., directly contact) the second surface SF2 of the support plate PLT. The second adhesive part AM2 may be formed along portions of outer sides of the first support plate PLT1 and the second support plate PLT2.

The first adhesive part AM1 and the second adhesive part AM2 may be formed in the same layer. The second adhesive part AM2 may be spaced apart from the first adhesive part AM1. The second adhesive part AM2 may include a plurality of second adhesive parts. The second adhesive parts AM2 may be spaced apart from each other in the first direction DR1, such that the curved surface part CSP is interposed between the second adhesive parts AM2.

The first adhesive part AM1 and the second adhesive part AM2 may include mutually different materials. For example, the first adhesive part AM1 may include a liquid adhesive agent such as glue. The liquid adhesive agent may have bonding force higher than bonding force of pressure sensitive adhesive (PSA) or optically clear adhesive (OCA). In addition, since the liquid adhesive agent may have a wider bonding region, the support plate PLT may be more firmly bonded to the support part PP.

The second adhesive part AM2 may include a transparent adhesive such as, for example, pressure sensitive adhesive (PSA) or optically clear adhesive (OCA), but the type of the adhesive is not limited thereto. For example, although the above description has been made in that the first adhesive part AM1 and the second adhesive part AM2 include different materials, the present disclosure is not limited thereto. For example, the first adhesive part AM1 and the second adhesive part AM2 may include the same material according to embodiments.

A first groove HM1 may be defined to be adjacent to the first adhesive part AM1, in the second surface SF2 of the support plate PLT. The thickness of the support plate PLT may be greater than a depth of the first groove HM1. The first groove HM1 may be formed through a half-etching process. However, this is provided only for the illustrative purpose, and the manner of forming the first groove HM1 is not limited thereto. For example, in an embodiment, the first groove HM1 may be formed through a machining manner such as a partially-cutting manner or a laser-half cut manner.

The first groove HM1 may control the flowing of the first adhesive part AM1. The first groove HM1 may function as a dam to control the flowing of the first adhesive part AM1. The first groove HM1 may control the first adhesive part AM1 to prevent flowing over the first support plate PLT1, the second support plate PLT2, and the folding part PLT_F.

For example, according to an embodiment, a first groove HM1 may be defined in the second surface SF2 of the support plate PLT, adjacent to the first adhesive part AM1. The first groove HM1 may serve to contain and regulate the application of the adhesive. In an embodiment, the first groove HM1 may be formed such that its depth is less than the overall thickness of the support plate PLT, thereby maintaining the structural integrity of the support plate PLT. The formation of the groove HM1 is not limited to a particular process. For example, while the groove may be formed using a half-etching process, alternative machining techniques may also be employed. These may include, but are not limited to, partial cutting methods or laser-assisted half-cutting techniques, which allow precise control over the first groove's HM1 depth and profile depending on the adhesive type and application requirements.

In an embodiment, the first groove HM1 may be configured to manage the behavior of the first adhesive part AM1 during application and curing. For example, the first groove HM1 may act as a physical barrier that limits the lateral flow of the adhesive, effectively functioning as a dam that prevents the adhesive from spreading into undesired areas. This may be beneficial in regions where adhesive overflow could interfere with the operation or folding behavior of the device. For example, the first groove HM1 may prevent the adhesive from spilling over onto the first support plate PLT1, the second support plate PLT2, or the folding part PLT_F. By spatially confining the adhesive to a designated region, the first groove HM1 can contribute to uniform bonding, reduce the risk of delamination, and enhance the overall reliability of the foldable structure.

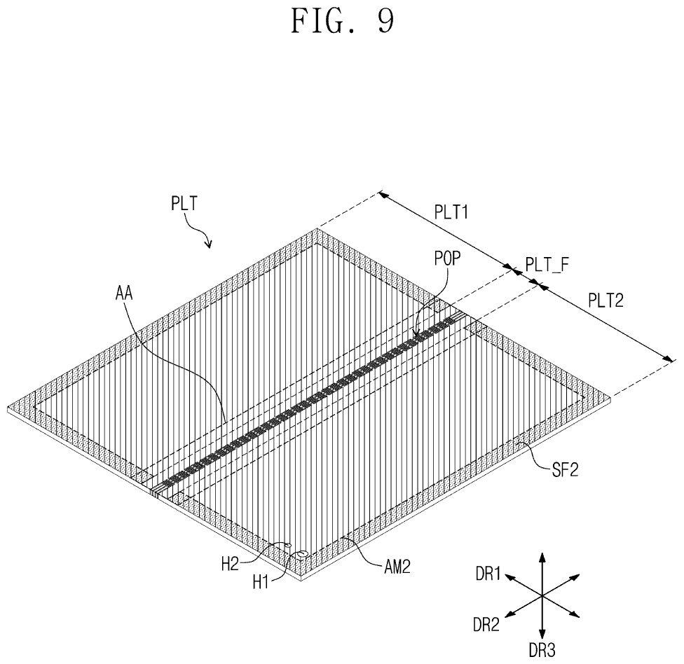

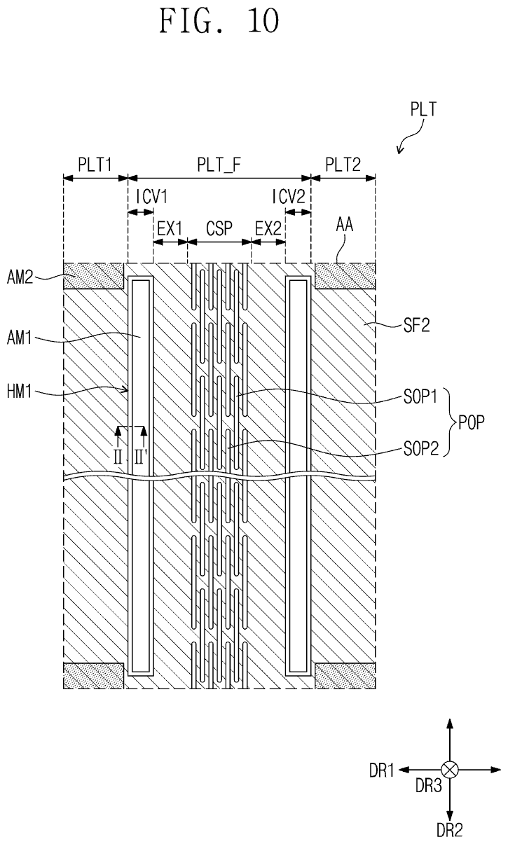

FIG. 9 is a perspective view of a support plate illustrated in FIG. 8. FIG. 10 is an enlarged plan view of a region AA illustrated in FIG. 9.

Referring to FIGS. 9 and 10, the support plate PLT may include the first support plate PLT1, the folding part PLT_F, and the second support plate PLT2 arranged in the first direction DR1. The folding part PLT_F may include the first inverse curvature part ICV1, the first extending part EX1, the second extending part EX2, and the second inverse curvature part ICV2 arranged in the first direction.

FIG. 9 illustrates the second surface SF2 of the support plate PLT.

A lattice pattern may be defined in the curved surface part CSP. For example, the openings POP defined in the curved surface part CSP may be arranged according to a specific pattern or rule. The openings POP may be arranged in the form of a lattice to form the lattice pattern of the curved surface part CSP.

The first adhesive part AM1 may include a plurality of first adhesive parts. For example, the first adhesive parts AM1 may overlap the first inverse curvature part ICV1 and the second inverse curvature part ICV2. The first adhesive parts AM1 may be spaced apart from each other in the first direction DR1, such that the curved surface part CSP is interposed between the first adhesive parts AM1. The first adhesive parts AM1 may be symmetrical to each other about the folding part PLT_F.

The second surface SF2 of the support plate PLT may be etched in the third direction DR3 to define the first groove HM1. The first groove HM1 may be defined to be adjacent to the first adhesive part AM1. For example, when viewed in a plan view, the first groove HM1 may have the shape of a rectangle to surround the first adhesive part AM1. However, the shape of the first groove HM1 is not limited thereto. For example, the first groove HM1 may have various shapes according to embodiments.

The second adhesive part AM2 may contact the second surface SF2 of the support plate PLT. The second adhesive part AM2 may be formed along portions of outer sides of the first support plate PLT1 and the second support plate PLT2. The second adhesive part AM2 may include a plurality of second adhesive parts AM2, and the second adhesive parts AM2 may be arranged to be spaced apart from each other in the first direction DR1. The second adhesive parts AM2 may be symmetrical to each other about the folding part PLT_F.

The openings POP may extend with a longer length in the second direction DR2 than the first direction DR1. The openings POP may include a plurality of first sub-openings SOP1 arranged in the second direction DR2, and a plurality of second sub-openings SOP2 adjacent to the first sub-openings SOP1 in the first direct0ion DR1 and arranged in the second direction DR2. The first sub-openings SOP1 may be arranged to be offset from the second sub-openings SOP2.

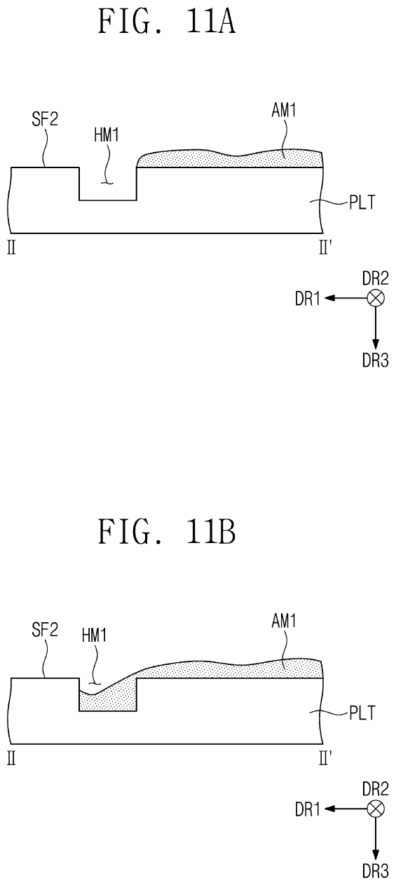

FIGS. 11A and 11B are cross-sectional views taken along II-II′ illustrated in FIG. 10.

Referring to FIGS. 11A and 11B, the first adhesive part AM1 may be disposed on the second surface SF2 of the support plate PLT. The first adhesive part AM1 may be a liquid adhesive agent. The first groove HM1 may be defined in a boundary of a region for applying the first adhesive part AM1 to control the flowing of the first adhesive part AM1.

The thickness of the support plate PLT may be greater than a depth of the first groove HM1. The first groove HM1 may be defined by performing a half-etching process for the second surface SF2 of the support plate PLT.

As illustrated in FIG. 11A, the first adhesive part AM1 may be prevented from flowing over the first groove HM1 due to surface tension at a boundary of the first groove HM1 adjacent to the first adhesive part AM1.

As illustrated in FIG. 11B, the first adhesive part AM1 may flow into the first groove HM1 at the boundary of the first groove HM1. The first groove HM1 may be defined in the form of a space to receive the first adhesive part AM1. The first groove HM1 may function as a dam or a drain to prevent the first adhesive part AM1 from flowing over a region other than the applying region. Accordingly, the first groove HM1 may compensate for the step difference between the support plate PLT and the lower members.

For example, referring to FIGS. 11A and 11B, the first adhesive part AM1 may be applied to the second surface SF2 of the support plate PLT. The first adhesive part AM1 may be a liquid adhesive agent, such as glue, and is configured to bond the support plate PLT to an underlying component. To regulate the spread of the adhesive during application, the first groove HM1 may be formed in the second surface SF2 at the boundary of the intended adhesive region. The first groove HM1 may act to confine the liquid adhesive by utilizing surface tension (as shown in FIG. 11A) and may also serve as a physical recess into which excess adhesive can flow (as shown in FIG. 11B). The first groove HM1 may thus reduce the likelihood of unintended adhesive spread, for example, in curved or folding regions. The depth of the first groove HM1 may be less than the overall thickness of the support plate PLT. In an embodiment, the first groove HM1 is recessed in the thickness direction of the support plate PLT, and thus, limits a flow of the first adhesive part AM1 beyond the boundary separating the first groove HM1 and the first adhesive part AM1. In an embodiment, the first groove HM1 may be formed by a half-etching process applied to the second surface SF2. However, other machining methods such as partial cutting or laser-based processing may also be used to form the groove.

According to an embodiment, the first groove HM1 may primarily prevent the first adhesive part AM1 from being applied to a region other than the first and second inverse curvature parts ICV1 and ICV2 using the surface tension at the edge part of the boundaries of the first and second inverse curvature parts ICV1 and ICV2. Even if errors may be made in the applying work, the first groove HM1 may secondarily prevent the first adhesive part AM1 from being applied to the region other than the first and second inverse curvature parts ICV1 and ICV2 by utilizing the dam or the drain recessed in the thickness direction. For example, the first groove HM1 may prevent or remove a phenomenon in which the first adhesive part AM1 is applied to an undesirable region. Accordingly, the electronic device DD (see FIG. 8) improved in reliability may be provided.

For example, according to an embodiment, the first groove HM1 may serve to control the application of the first adhesive part AM1 by performing two functions. As a first function, the first groove HM1 may utilize surface tension at its edge to prevent the first adhesive part AM1 from spreading beyond the intended application region, for example, outside the first and second inverse curvature parts ICV1 and ICV2. As a second function, in cases where adhesive application errors occur, the recessed structure of the first groove HM1 in the thickness direction may act as a dam or drain to trap and contain excess adhesive. In this way, the first groove HM1 may prevent or eliminate undesired adhesive flow into adjacent regions. As a result, unintended spreading of the first adhesive part AM1 can be avoided, thereby contributing to improved reliability of the electronic device DD (see FIG. 8).

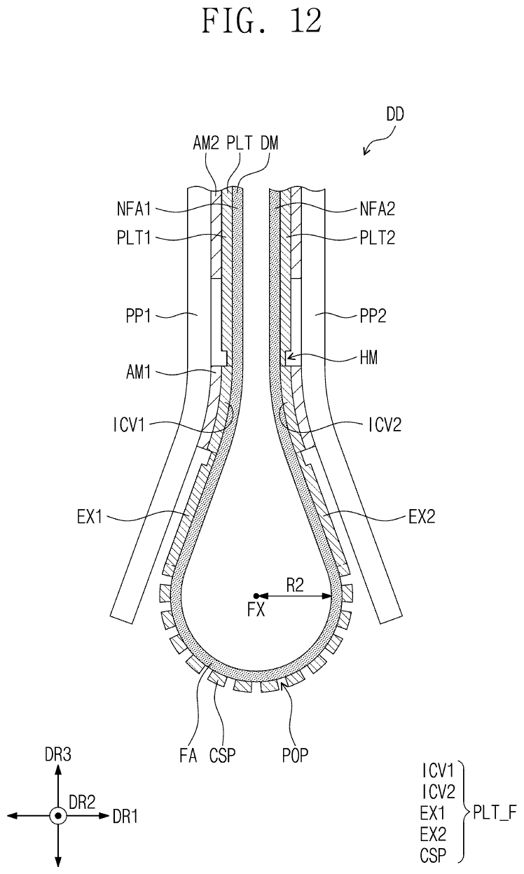

FIG. 12 is a view illustrating an electronic device in a folding state, illustrated in FIG. 8.

FIG. 12 illustrates the display module DM in a single layer. In addition, for convenience of illustration, the support plate PLT, the adhesive parts AM1 and AM2, and the support part PP are illustrated together with the display module DM, and other components are omitted.

For example, the boundaries among the first and second support plates PLT1 and PLT2, the curved surface part CSP, the first and second extending parts EX1 and EX2, and the first and second inverse curvature parts ICV1 and ICV2 are illustrated in the form of dotted lines on the support plate PLT (see FIG. 10).

Referring to FIG. 12, the support plate PLT may be folded about the folding axis FX. The support plate PLT may be folded in the form of a dumbbell. As the support plate PLT is folded, the display module DM may be folded together with the support plate PLT.

The folding part PLT_F may be folded about the folding axis FX to fold the support plate PLT. When the folding part PLT_F is folded, the curved surface part CSP may be bent to have a specific curvature. For example, the folding region FA of the display module DM on the curved surface part CSP may be bent to have the radius R2 of curvature.

The first inverse curvature part ICV1 may be bent to be opposite to the curved surface part CSP. The second inverse curvature part ICV2 may be bent to be opposite to the curved surface part CSP. The second inverse curvature part ICV2 may have a shape symmetrical to a shape of the first inverse curvature part ICV1.

When the folding part PLT_F is folded, the first support plate PLT1 and the second support plate PLT2 may be maintained in a flat state. Accordingly, the first and second non-folding regions NFA1 and NFA2 may be maintained in the flat state by the first and second support plates PLT1 and PLT2.

The first extending part EX1 may be maintained in the flat state between the curved surface part CSP and the first inverse curvature part ICV1. The first extending part EX1 may extend in the flat state from the first inverse curvature part ICV1 toward the curved surface part CSP.

The second extending part EX2 may be maintained in the flat state between the curved surface part CSP and the second inverse curvature part ICV2. The second extending part EX2 may extend in the flat state from the second inverse curvature part ICV2 toward the curved surface part CSP.

When the folding part PLT_F is folded, the curved surface part CSP may be bent together with the first inverse curvature part ICV1. The curved surface part CSP may be bent in the shape corresponding to the first inverse curvature part ICV1. A portion, which overlaps the curved surface part CSP and the first inverse curvature part ICV1, of the first support part PP1 may be bent together with the curved surface part CSP and the first inverse curvature part ICV1.

When the folding part PLT_F is folded, the curved surface part CSP may be bent together with the second inverse curvature part ICV2. The curved surface part CSP may be bent in the shape corresponding to the second inverse curvature part ICV2. A portion, which overlaps the curved surface part CSP and the second inverse curvature part ICV2, of the second support part PP2 may be bent together with the curved surface part CSP and the second inverse curvature part ICV2.

A portion, which overlaps the first extending part EX1, of the first support part PP1 may maintain the shape flat together with the first extending part EX1, when the folding part PLT_F is folded. A portion, which overlaps the second extending part EX2, of the second support part PP2 may maintain the shape flat together with the second extending part EX2, when the folding part PLT_F is folded.

Referring to FIGS. 8 and 12, since the first adhesive part AM1 is not disposed on the curved surface part CSP, portions, which overlap the curved surface part CSP, of the first and second support parts PP1 and PP2 are not bent together with the curved surface part CSP.

For example, the first adhesive part AM1 may be bent together with the first inverse curvature part ICV1 and the second inverse curvature part ICV2, when the folding part PLT_F is folded. Since the first inverse curvature part ICV1 and the second inverse curvature part ICV2 are bent, the first adhesive part AM1 is configured to have stronger bonding force with the first inverse curvature part ICV1 and the second inverse curvature part ICV2. Thus, according to embodiments, the first adhesive part AM1 may include a liquid adhesive agent such as glue. The first adhesive part AM1 may have a higher bonding force. When the folding part PLT_F is folded, the first adhesive part AM1 may prevent or remove a phenomenon in which the surface of the folding part PLT_F is furrowed or irregularly deformed by external force or stress. The first adhesive part AM1 may provide strong bonding between the display module DM and the support plate PLT, and a lower set, in the folding region FA.

Referring to FIGS. 8 and 12, since the first adhesive part AM1 is a liquid adhesive agent, the first adhesive parts AM1 may be applied with a thinner thickness to the first inverse curvature part ICV1 and the second inverse curvature part ICV2. In addition, the first adhesive part AM1 is controlled to be prevented from flowing to a region other than the applying region by the first groove HM1. Accordingly, the first adhesive parts AM1 may be uniformly applied to the first inverse curvature part ICV1 and the second inverse curvature part ICV2. Accordingly, the first adhesive part AM1 may prevent or remove the buckling and the delamination when the folding part PLT_F is folded.

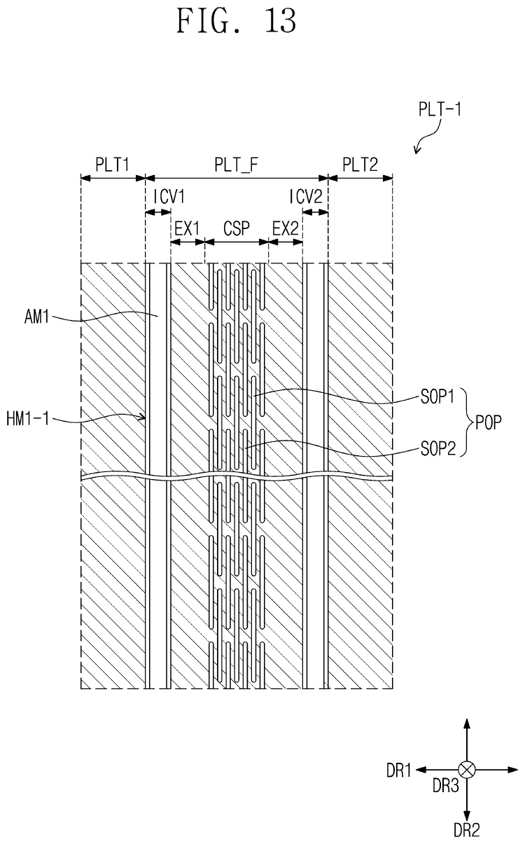

FIG. 13 is a plan view of a support plate of an electronic device according to an embodiment of the present disclosure.

FIG. 13 illustrates a plan view corresponding to FIG. 10. Hereinafter, components of a support plate PLT-1 of FIG. 13 will be described while focusing on components different from the components illustrated in FIG. 10.

Referring to FIG. 13, a plurality of first grooves HM1-1 may be provided. Each of the first grooves HM1-1 may extend in the second direction DR2. Each of the first grooves HM1-1 may be defined out of a support plate PLT-1 along the boundary of the first inverse curvature part ICV1 or the second inverse curvature part ICV2.

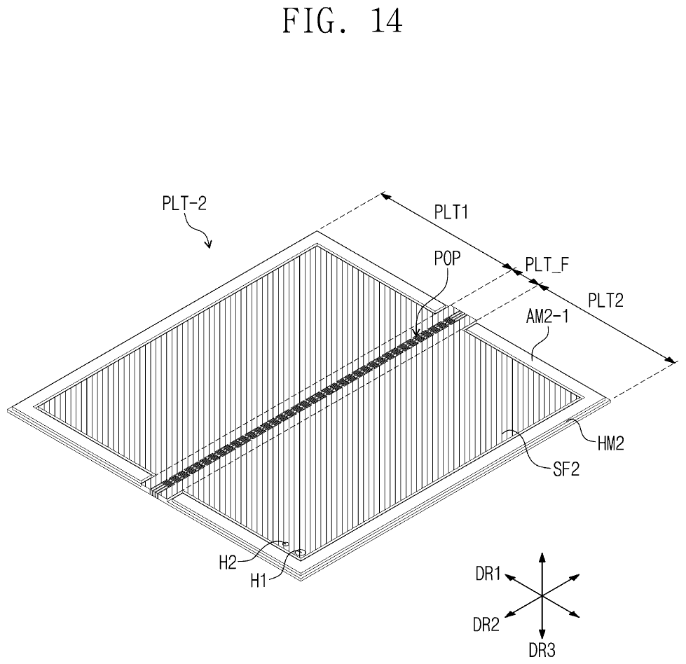

FIG. 14 is a perspective view of a support plate of an electronic device according to an embodiment of the present disclosure.

FIG. 14 illustrates a perspective view corresponding to FIG. 9. Hereinafter, components of a support plate PLT-2 of FIG. 14 will be described while focusing on components different from the components illustrated in FIG. 9.

Referring to FIG. 14, a second groove HM2 may further be defined in the second surface FS2 of the support plate PLT-2 to surround a second adhesive part AM2-1.

When the second adhesive part AM2-1 includes a liquid adhesive agent such as glue, the second groove HM2 may control the flowing of the second adhesive part AM2-1.

The second groove HM2 may prevent the second adhesive part AM2-1 from flowing to a region other than the applying region. When the second adhesive part AM2-1 is the liquid adhesive agent, the bonding force between the support plate PLT-2 and the support part PP (see FIG. 8) may be increased.

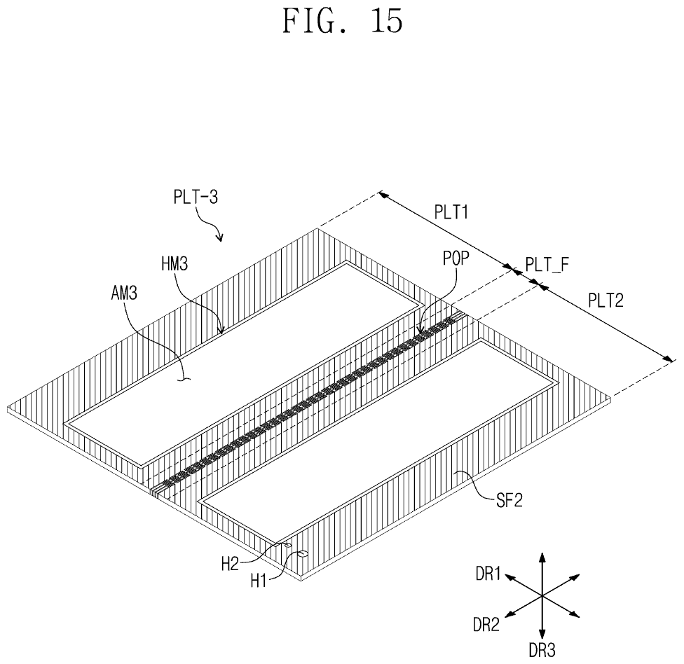

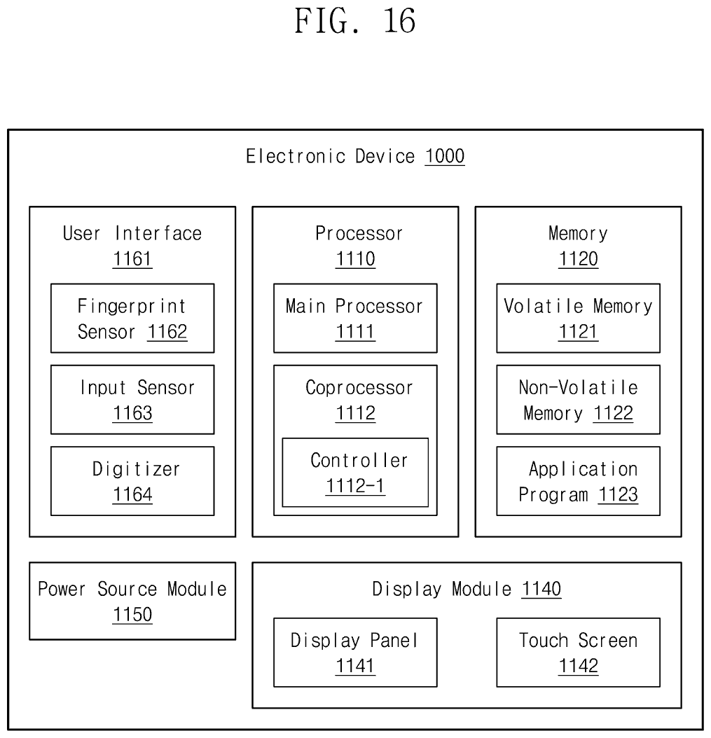

FIG. 15 is a perspective view of a support plate of an electronic device according to an embodiment of the present disclosure.

FIG. 15 illustrates a perspective view corresponding to FIG. 9. Hereinafter, components of a support plate PLT-3 of FIG. 15 will be described while focusing on components different from the components illustrated in FIG. 9.

Referring to FIGS. 10 and 15, a third adhesive part AM3 may contact (e.g., directly contact) the second surface SF2 of the support plate PLT-3. The third adhesive part AM3 may overlap the first support plate PLT1 and the second support plate PLT2. The third adhesive part AM3 and the first adhesive part AM1 may be disposed in the same layer (see FIG. 10).

The third adhesive part AM3 may include a plurality of third adhesive parts. The plurality of third adhesive parts AM3 may be spaced apart from each other in the first direction DR1. For example, the third adhesive parts AM3 may overlap the first cushion layer CS1 (see FIG. 8) and the second cushion layer CS2 (see FIG. 8), respectively.

Since the third adhesive part AM3 overlaps the first support plate PLT1 and the second support plate PLT2, the third adhesive part AM3 may provide stronger bonding between the support plate PLT-1 and the support part PP.

Although the adhesive part AM3 may include a transparent adhesive agent, such as a pressure sensitive adhesive (PSA) or an optically clear adhesive (OCA), the type of the adhesive agent is not limited thereto. For example, although the above description has been made with reference to FIG. 14 in that the first adhesive part AM1 and the third adhesive part AM3 include different materials, the present disclosure is not limited thereto.

For example, a third groove HM3 may be defined in the support plate PLT-3 to surround the third adhesive part AM3, when the third adhesive part AM3 is a liquid adhesive agent. The third groove HM3 may prevent the third adhesive part AM3 from flowing to a region other than the applying region.

According to an embodiment of the present disclosure, the first adhesive part AM1 may be omitted. In this case, the support plate PLT-3 may be easily bonded to the lower members by the third adhesive part AM3. A buckling phenomenon, which may be caused when the folding part PLT_F is folded, as the folding part PLT_F is not bonded to the lower members, may be prevented or removed.

As described above, according to embodiments of the present disclosure, the first groove may primarily prevent the first adhesive part from being applied to a region other than the first and second inverse curvature parts using the surface tension at the edge part of the boundaries of the first and second inverse curvature parts. Even if application errors occur, the first groove may secondarily prevent the first adhesive part from being applied to the region other than the first and second inverse curvature parts by utilizing, as the dam or the drain, a part recessed in the thickness direction. For example, the first groove may prevent or remove a phenomenon in which the first adhesive part is applied to an undesirable region. Accordingly, an electronic device with improved reliability may be provided.

FIG. 16 is a diagram illustrating an electronic device according to an embodiment of the present disclosure.

Referring to FIG. 16, the electronic device 1000 according to an embodiment of the present disclosure may output various information (e.g., images, text, music, etc.) through a display module 1140, which, for example, may correspond to the display module DM described above. When a processor 1110 executes an application stored in a memory 1120, the display module 1140 may provide application information to a user through a display panel 1141.

In some embodiments, the electronic device 1000 may be configured as, for example, a smartphone, camera, smart TV, monitor, smartwatch, tablet, automotive display, or AR/VR headset. For example, the electronic device 1000 may be a smartphone including a touch-sensitive display area DA for interaction and a non-display area NDA including sensors and circuits for enhanced functionality. For example, the electronic device 1000 may be a television or monitor including a large display area DA for high-resolution video playback and a non-display area NDA incorporating driving circuits or connectivity modules for external inputs. For example, the electronic device 1000 may be a smartwatch including a display area DA optimized for compact and high-clarity visuals and a non-display area NDA integrating biometric sensors for health monitoring. In some cases, the electronic device 1000 be an AR/VR headset.

In some embodiments, memory 1120 may store information such as software codes for operating an application program 1123. The application program 1123 may include software designed to execute specific tasks or provide functionality to a user. The application program 1123 may operate under the control of the processor 1110 and utilizes data stored in the memory 1120 to deliver a wide range of features, such as, for example, productivity tools, multimedia streaming and playback, file or mail deliveries or communication services. The application program 1123 interacts seamlessly with the user interface 1161 or touch screen 1142, allowing a user to launch, navigate, and utilize the program through user inputs such as, for example, touch, tap, gesture, or voice interaction.

Upon user selection of an application via touch screen 1142 or user interface 1161, the processor 1110 may execute the application program 1123 corresponding to the selected application retrieved from the memory 1120 to perform functionalities of the application. For example, when a user selects a camera application by tapping the icon (or a camera application icon) presented on the display panel 1141, the processor 1110 activates a camera module. The processor 1110 may transmit image data corresponding to a captured image acquired through the camera module to the display module 1140. The display module 1140 may display an image corresponding to the captured image through the display panel 1141.

In an embodiment, when a user wishes to make a phone call, the user taps the telephone icon displayed on the display module 1140, and the processor 1110 may execute a phone application program stored in the memory 1120. A telephone keypad may be presented on the display panel 1141 for the user to enter a phone number to call.

In an embodiment, the display module 1140 may be integrated into an electronic device 1000, such as, for example, a laptop computer, smart TV, or tablet. A user wishing to access a multimedia streaming application (e.g., to watch a music video or movie) can do so by tapping the corresponding icon. This action activates the application, allowing the user to view the streamed content.

The processor 1110 may include a main processor 1111 and an auxiliary or coprocessor 1112. The main processor 1111 may include a central processing unit (CPU). The main processor 1111 may further include one or more of a graphics processing unit (GPU), a communication processor (CP), and an image signal processor (ISP).

The coprocessor 1112 may include a controller 1112-1. The controller 1112-1 may include an interface conversion circuit and a timing control circuit. The controller 1112-1 may receive an image signal from the main processor 1111, convert the data format of the image signal to match the interface specifications with the display module 1140, and output image data. The controller 1112-1 may output various control signals to drive the display module 1140. For example, the controller 1112-1 may drive the display module 1140 to display the icon on the display screen suitable for selection by a user to cause execution of an application program 1123.

The memory 1120 may store one or more application programs 1123 and various data used by at least one component (for example, the processor 1110 or the user interface 1161) of the electronic device 1000 and input data or output data for commands related thereto. For example, a camera application program, a GPS application program, an augmented reality and virtual reality application program, and other application programs that can be executed by the processor 1110 upon selection of corresponding icons presented on the display screen (or display panel 1141) via the touch screen 1142 or user interface 1161 by the user. In addition, various setting data corresponding to user settings may be stored in the memory 1120. The memory 1120 may include volatile memory 1121 and non-volatile memory 1122.

The display module 1140 may output visual information (images) to the user. The display module 1140 may include the display panel 1141, a gate driver, the source driver, a voltage generation circuit, and a touch screen 1142. The display module 1140 may further include a window, a chassis, and a bracket to protect the display panel 1141. The display module 1140 may include at least a part of the configuration of the display module DM described above.

The user interface 1161 serves as the interaction medium between a user and the electronic device 1000. The user interface 1161 may detect an input by a part (e.g., finger) of a user's body or an input by a pen or a mouse, and generate an electric signal or data value corresponding to the input. The user interface 1161 includes the fingerprint sensor 1162, the input sensor 1163, and a digitizer 1164.

The fingerprint sensor 1162 may sense a fingerprint for biometric recognition of the user and may also measure one or more biological signals such as, for example, blood pressure, moisture, or body mass.

The input sensor 1163 may sense user interactions including, for example, touch, tap, gesture, motion, spoken command, and eye movement. The input sensor 1163 includes optical sensors for image capture, eye tracking, or motion and gesture detection. Optical sensors may be infrared or semiconductor photodetectors. The input sensor 1163 includes audio and acoustic sensors, which may be MEMS microphones for voice recognition or sound-based interaction. The audio and acoustic sensors can be installed as part of the user interface 1161 or embedded in the display panel 1141.

The digitizer 1164 may generate a data value corresponding to coordinate information of input by a pen or a mouse to control movement of an onscreen cursor. The digitizer 1164 may generate the amount of change in electromagnetic due to the input as the data value. The digitizer may detect an input by a passive pen or transmit and receive data with an active pen or a remote.

At least one of the fingerprint sensor 1162, the input sensor 1163, or the digitizer 1164 may be implemented as a sensor layer formed on the top layer of the display panel 1141 through a continuous process with a process of forming elements (for example, the light emitting element, the transistor, and the like) included in the display panel 1141.

In addition, the user interface 1161 may further include, for example, a gesture sensor, a gyro sensor that senses rotational movements, an acceleration sensor to track translational movement, a grip sensor, a pressure sensor, a proximity sensor, a color sensor, an infrared (IR) emitter and camera sensor for tracking gaze direction and eye movements, a temperature sensor, or a light sensor. For example, the gyro sensor, acceleration sensor, and infrared emitter and camera may be particularly suitable for AR/VR headset functions.

The touch screen 1142 includes touch sensors embedded in semiconductor layers of the display panel 1141 to sense pressure applied to the top layer (screen) of the display panel 1141. The touch sensors can be a capacitive or a resistive type. The touch screen 1142 may serve as the primary interface for the user to select and navigate applications, control, and interact with the electronic device 1000.

The display panel 1141 (or display) may include, for example, a liquid crystal display panel, an organic light emitting display panel, or an inorganic light emitting display panel. However, the type of the display panel 1141 is not particularly limited. The display panel 1141 may be of a rigid type or a flexible type that can be rolled or folded. The display module 1140 may further include a supporter, bracket, heat dissipation member, and the like that support the display panel 1141. The display panel 1141 may include the display module DM described above.

The power source module 1150 may supply power to the components of the electronic device 1000. The power source module 1150 may include a battery that charges the power source voltage. The battery may include a non-rechargeable primary battery or a rechargeable secondary battery or fuel cell. The power source module 1150 may include a power management integrated circuit (PMIC). The PMIC may supply optimized power to each of the components described above including the display module 1140.

While the present disclosure has been particularly shown and described with reference to embodiments thereof, it will be understood by those of ordinary skill in the art that various changes in form and detail may be made therein without departing from the spirit and scope of the present disclosure as defined by the following claims.

What is claimed is:

1. An electronic device, comprising:
a display module;
a support plate having a first surface that faces the display module, and a second surface that is opposite to the first surface,
wherein the support plate includes a first support plate, a second support plate, and a folding part interposed between the first support plate and the second support plate;
a first adhesive part contacting the second surface; and
a first groove defined in the second surface and adjacent to the first adhesive part,
wherein the first groove is recessed in a thickness direction of the support plate to limit a flow of the first adhesive part beyond a boundary separating the first groove and the first adhesive part.

2. The electronic device of claim 1, wherein the folding part includes:
a curved surface part;
a first inverse curvature part interposed between the first support plate and the curved surface part; and
a second inverse curvature part interposed between the second support plate and the curved surface part,
wherein the curved surface part is bent to have a specific curvature, and the first inverse curvature part and the second inverse curvature part are bent to be opposite to the curved surface part, when the folding part is folded.

3. The electronic device of claim 2, wherein the first adhesive part overlaps the first inverse curvature part and the second inverse curvature part.

4. The electronic device of claim 1, wherein a thickness of the support plate is thicker than a depth of the first groove.

5. The electronic device of claim 1, wherein the first support plate, the folding part, and the second support plate are arranged in a first direction,
wherein the first groove extends in a second direction crossing the first direction.

6. The electronic device of claim 1, further comprising:
a second adhesive part contacting the second surface of the support plate,
wherein the second adhesive part is formed along portions of outer sides of the first support plate and the second support plate.

7. The electronic device of claim 6, wherein the first adhesive part and the second adhesive part are disposed in a same layer.

8. The electronic device of claim 7, wherein the second adhesive part is spaced apart from the first adhesive part.

9. The electronic device of claim 6, wherein the second adhesive part and the first adhesive part include different materials.

10. The electronic device of claim 6, further comprising:
a second groove defined in the second surface of the support plate and surrounding the second adhesive part.

11. The electronic device of claim 10, further comprising:
a third adhesive part contacting the second surface of the support plate,
wherein the third adhesive part overlaps the first support plate and the second support plate.

12. The electronic device of claim 11, wherein the first adhesive part and the third adhesive part are disposed in a same layer.

13. The electronic device of claim 11, further comprising:
a third groove defined in the second surface of the support plate and surrounding the third adhesive part.

14. The electronic device of claim 11, wherein the third adhesive part and the first adhesive part include different materials.

15. An electronic device, comprising:
a display module;
a support plate disposed under the display module and including a first support plate, a second support plate, and a folding part interposed between the first support plate and the second support plate,
wherein the first support plate, the second support plate, and the folding part are arranged in a first direction;
a support part disposed under the support plate, and including a first support part corresponding to the first support plate and a second support part corresponding to the second support plate;
a first adhesive part interposed between the support plate and the support part; and
a groove defined in a surface of the support plate that faces the first adhesive part,
wherein the groove surrounds the first adhesive part.

16. The electronic device of claim 15, wherein the first adhesive part overlaps the folding part,
wherein the first adhesive part includes a plurality of first adhesive parts, and the plurality of first adhesive parts are spaced apart from each other in the first direction.

17. The electronic device of claim 15, further comprising:
a second adhesive part disposed under the support plate and spaced apart from the first adhesive part,
wherein the first adhesive part and the second adhesive part are disposed in a same layer.

18. The electronic device of claim 17, wherein the second adhesive part is disposed along a portion of an outer side of each of the first support plate and the second support plate,
wherein the second adhesive part includes a plurality of second adhesive parts, and the plurality of second adhesive parts are spaced apart from each other in the first direction.

19. The electronic device of claim 15, further comprising:
a cushion layer disposed under the support part, and including a first cushion layer and a second cushion layer,
wherein the first cushion layer overlaps the first support part,
wherein the second cushion layer overlaps the second support part.

20. The electronic device of claim 19, further comprising:
a second adhesive part disposed under the support plate and spaced apart from the first adhesive part; and
a third adhesive part disposed under the support plate,
wherein the third adhesive part includes a plurality of third adhesive parts, and the plurality of third adhesive parts are spaced apart from each other in the first direction,
wherein the plurality of third adhesive parts overlap the first cushion layer and the second cushion layer, respectively.
